(19) United States
(12) Patent Application Publication
(10) Pub. No.: US 2026/0257709 A1
(43) Pub. Date: Sep. 3, 2026

(54) WIRELESS TRAIN CONTROL SYSTEM AND FORMATION NUMBER ACQUISITION METHOD

(71) Applicant: Mitsubishi Electric Corporation, Chiyoda-ku, Tokyo (JP)

(72) Inventors: Tatsuhiko MURAKAMI, Tokyo (JP); Takashi MIYAUCHI, Tokyo (JP); Tsutomu ITO, Tokyo (JP); Ryosuke OKADA, Tokyo (JP)

(73) Assignee: Mitsubishi Electric Corporation, Chiyoda-ku, Tokyo (JP)

(21) Appl. No.: 18/995,723

(22) PCT Filed: Aug. 23, 2022
(86) PCT No.: PCT/JP2022/031722

§ 371 Date: Jan. 16, 2025

(51) Int. Cl. B61L 27/70; B61L 25/04

(52) U.S. Cl. CPC B61L 27/70; B61L 25/04

(57) ABSTRACT

A wireless train control system includes: an on-board control device that is installed on a specified car in a train having a redundant transmission system, in which identification information for performing communication in any of the transmission system is set in the on-board control device; a train information management device that is installed on a specified car and collects the identification information; a wireless on-board station that acquires the identification information from the train information management device and transmits a combination of the identification information; a wireless ground base station that receives a combination of the identification information; and a ground control device that uses a combination of the identification information to search a database in which a correspondence between a combination of the identification information and a formation number of the train is registered, and transmits a search result to the train via the wireless ground base station.

### FIELD

The present disclosure relates to a wireless train control system and a formation number acquisition method for controlling operation of a train through wireless communication.

### BACKGROUND

Conventionally, in a railway field, a formation number for identifying a train is used in train operation control, train maintenance work, and the like. For example, Patent Literature 1 discloses a technique for acquiring information on a formation number of a train on which equipment is installed, together with information indicating a type of the equipment to be installed on the train, information indicating a state of the equipment, and the like, in maintenance work of the train. In general, when equipment installed on a train is removed from the train because of repair, inspection, or the like, the equipment may be installed on another train instead of the original train. However, by the use of the technique described in Patent Literature 1, it is possible to obtain information on what type of train the equipment installed on a train is installed on and how the equipment has been used, and thus such information can be used for maintenance work.

### CITATION LIST

### Patent Literature

Patent Literature 1: International Publication No. 2017/195408

### SUMMARY OF INVENTION

### Problem to be Solved by the Invention

An on-board control device installed on a train compatible with wireless train control recognizes a formation number of a train on which the on-board control device is installed, by using a connector for recognizing formation number and a digital input (DI) that is input to the connector for recognizing formation number. The connector for recognizing formation number cannot be replaced in a state where the on-board control device is installed on a train so that a formation number of the train is not changed. The connector for recognizing formation number receives input in binary numbers, and it is necessary to increase the number of DIs as the number of train formations increases. For example, when there are 128 train formations, the connector for formation number recognition requires a total of at least eight inputs including seven for 7 bits for the DIs and one for earth. Therefore, there has been a problem in the on-board control device that it is necessary to increase the number of inputs of the connectors for formation number recognition as the number of train formations increases, and it is necessary to change a hardware configuration.

The present disclosure has been made in view of the above, and an object of the present disclosure is to provide a wireless train control system in which an on-board control device can acquire information on a formation number of a train on which the on-board control device is installed, without changing hardware depending on the number of the train formations that exist.

### Means to Solve the Problem

To solve the above problem and achieve an object, a wireless train control system according to the present disclosure includes: an on-board control device installed on a specified car in a train having a redundant transmission system, in which identification information for performing communication in any transmission system in the redundant transmission system is set for the on-board control device; a train information management device to collect the identification information from the on-board control device, the train information management device being installed on the specified car; a wireless on-board station to acquire the identification information from the train information management device and transmit a combination of the identification information; a wireless ground base station to receive a combination of the identification information; and a ground control device to perform control to use a combination of the identification information to search a database in which a correspondence between a combination of the identification information and a formation number of the train is registered, and transmit a search result to the train via the wireless ground base station. The train information management device acquires the search result via the wireless on-board station and notifies the on-board control device of the search result. The on-board control device performs control based on the acquired search result.

### Effects of the Invention

The wireless train control system of the present disclosure has an effect of enabling an on-board control device to acquire information on a formation number of a train on which the on-board control device is installed, without changing hardware depending on the number of the train formations that exist.

### BRIEF DESCRIPTION OF DRAWINGS

FIG. 1 is a diagram illustrating an exemplary configuration of a wireless train control system according to an embodiment.

FIG. 2 is a diagram illustrating an exemplary configuration of a train according to the embodiment.

FIG. 3 is a diagram illustrating a database held by a ground control device in the wireless train control system and a state of search processing of the ground control device, according to the embodiment.

FIG. 4 is a flowchart illustrating an operation of each device when the on-board control device of the train acquires information on a formation number in the wireless train control system according to the embodiment.

FIG. 5 is a diagram illustrating an exemplary configuration of processing circuitry in a case where processing circuitry included in the wireless train control system according to the embodiment is implemented by a processor and a memory.

FIG. 6 is a diagram illustrating an exemplary configuration of processing circuitry in a case where processing circuitry included in the wireless train control system according to the embodiment is implemented by dedicated hardware.

### DESCRIPTION OF EMBODIMENTS

Hereinafter, a wireless train control system and a formation number acquisition method according to an embodiment of the present disclosure will be described in detail with reference to the drawings.

### Embodiment

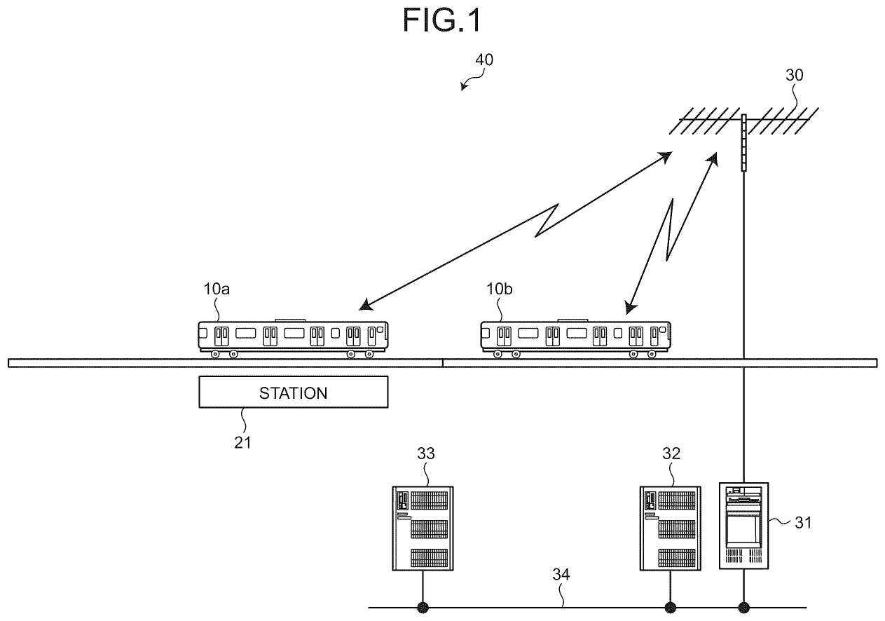

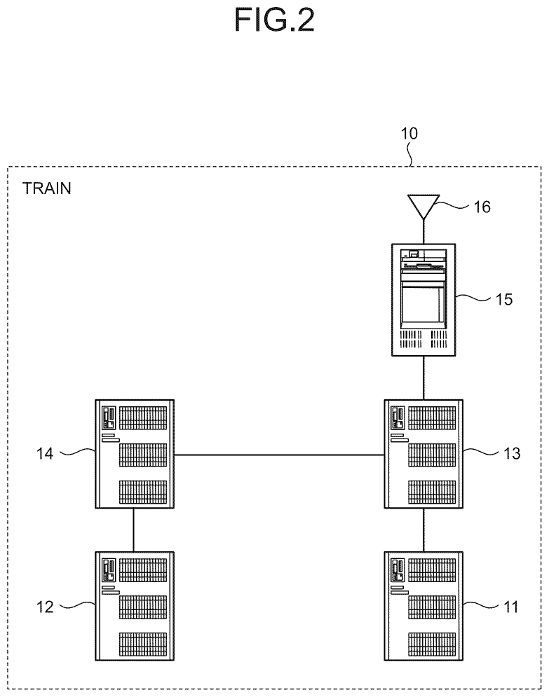

FIG. 1 is a diagram illustrating an exemplary configuration of a wireless train control system 40 according to the present embodiment. The wireless train control system 40 includes trains 10a and 10b, a ground antenna 30, a wireless ground base station 31, a ground control device 32, a ground terminal 33, and a ground network 34. The wireless train control system 40 includes two trains, that is, the trains 10a and 10b in the example of FIG. 1, but may include three or more trains. FIG. 1 illustrates a state in which the train 10a stops at a station 21, and the train 10b stops at a detention line or the like. In the following description, the trains 10a and 10b may be referred to as a train 10 when not distinguished from each other. FIG. 2 is a diagram illustrating an exemplary configuration of the train 10 according to the present embodiment. The train 10 includes on-board control devices 11 and 12, train information management devices 13 and 14, a wireless on-board station 15, and an on-board antenna 16.

The on-board control devices 11 and 12 are installed on a specified car in the train 10 having a redundant transmission system (not illustrated). For example, assuming that the right side in FIG. 2 is a traveling direction of the train 10, the on-board control device 11 is installed on a front car of the train 10 that is a specified car, and the on-board control device 12 is installed on a rear car of the train 10 that is a specified car. When the left side in FIG. 2 is a traveling direction of the train 10, the on-board control device 11 is installed on the rear car of the train 10 that is a specified car, and the on-board control device 12 is installed on the front car of the train 10 that is a specified car.

The on-board control device 11 includes a substrate functioning as an on-board control device in each transmission system, in order to perform transmission of control information and the like with an on-board device (not illustrated) in the redundant transmission system. For the substrate functioning as the on-board control device, identification information for performing communication in any transmission system is set. For example, when the redundant transmission system includes two systems of a first system and a second system, the on-board control device 11 includes: an on-board control device substrate that performs transmission of control information and the like with an on-board device in a transmission system of the first system and functions as one on-board control device; and an on-board control device substrate that performs transmission of control information and the like with an on-board device in a transmission system of the second system and functions as one on-board control device. On each on-board control device substrate, a unique media access control (MAC) address that is the identification information described above and is necessary for communication with the on-board device in the transmission system is set in a manufacturing stage of each on-board control device substrate or a manufacturing stage of the on-board control device 11. For example, when the first system and the second system of the redundant transmission system each are networks compatible with Ethernet (registered trademark), the MAC address is an address for performing communication in one channel of Ethernet. As described above, the on-board control device 11 is configured with one housing in appearance, but includes on-board control device substrates functioning as the on-board control device, and the number of the substrates corresponds to a redundant number of the redundant transmission system. In the example of FIG. 2, since the on-board control device 11 includes the on-board control device substrates functioning as the on-board control device for two systems, that is, two substrates, two MAC addresses are set at the manufacturing stage of the on-board control device 11.

Similarly, the on-board control device 12 includes a substrate functioning as an on-board control device in each transmission system, in order to perform transmission of control information and the like with an on-board device (not illustrated) in the redundant transmission system. Identification information for performing communication in any transmission system is set for the substrate functioning as the on-board control device. For example, when the redundant transmission system includes two systems of a first system and a second system, the on-board control device 12 includes: an on-board control device substrate that performs transmission of control information and the like with an on-board device in a transmission system of the first system and functions as one on-board control device; and an on-board control device substrate that performs transmission of control information and the like with an on-board device in a transmission system of the second system and functions as one on-board control device. On each on-board control device substrate, a unique MAC address that is the identification information described above and is necessary for communication with the on-board device in the transmission system is set in a manufacturing stage of each on-board control device substrate or a manufacturing stage of the on-board control device 12. As described above, the on-board control device 12 is configured with one housing in appearance, but includes on-board control device substrates functioning as the on-board control devices, and the number of the substrates corresponds to a redundant number of the redundant transmission system. In the example of FIG. 2, since the on-board control device 12 includes the on-board control device substrates functioning as the on-board control device for two systems, that is, two substrates, two MAC addresses are set at the manufacturing stage of the on-board control device 12.

Thus, the train 10 includes, for the redundant transmission system, the on-board control device for the first system and the on-board control device for the second system, specifically, the substrate functioning as the on-board control device for the first system and the substrate functioning as the on-board control device for the second system, respectively in a front car and a rear car that are specified cars. Further, the identification information is a MAC address unique to each substrate functioning as the on-board control device.

The train information management devices 13 and 14 are installed on a specified car in the train 10 having the redundant transmission system (not illustrated). For example, assuming that the right side in FIG. 2 is a traveling direction of the train 10, the train information management device 13 is installed on a front car of the train 10 that is a specified car, and the train information management device 14 is installed on a rear car of the train 10 that is a specified car. When the left side in FIG. 2 is a traveling direction of the train 10, the train information management device 13 is installed on the rear car of the train 10 that is a specified car, and the train information management device 14 is installed on the front car of the train 10 that is a specified car.

The train information management device 13 collects a MAC address serving as the identification information described above, from the on-board control device 11. Specifically, the train information management device 13 acquires a MAC address set for each on-board control device substrate, that is, two MAC addresses, from the on-board control device 11. Similarly, the train information management device 14 collects a MAC address serving as the identification information described above, from the on-board control device 12. Specifically, the train information management device 14 acquires a MAC address set for each on-board control device substrate, that is, two MAC addresses, from the on-board control device 12. Here, the train information management device 14 outputs information about the two MAC addresses collected from the on-board control device 12, to the train information management device 13 of the car on which the wireless on-board station 15 is installed.

The wireless on-board station 15 is installed on one of specified cars in the train 10 having the redundant transmission system (not illustrated). In the present embodiment, it is assumed that the wireless on-board station 15 is installed on a car on which the on-board control device 11 and the train information management device 13 are installed. The wireless on-board station 15 acquires a MAC address serving as the identification information described above set in each on-board control device substrate, from the train information management device 13. Specifically, the wireless on-board station 15 directly acquires a MAC address serving as the identification information from the train information management device 13, which is a first train information management device installed on the car on which the wireless on-board station 15 is installed, and acquires a MAC address serving as the identification information from the train information management device 14, which is a second train information management device installed on a different car via the train information management device 13 which is the first train information management device. The wireless on-board station 15 transmits four MAC addresses in total including: the two MAC addresses set in the on-board control device 11 and directly acquired from the train information management device 13; and the two MAC addresses set in the on-board control device 12 and indirectly acquired from the train information management device 14 via the train information management device 13, as a combination of the identification information, that is, a combination of the MAC addresses, to the wireless ground base station 31 on the ground via the on-board antenna 16. The combination of MAC addresses is a combination of combinations of the four MAC addresses.

On the ground, the wireless ground base station 31 receives, via the ground antenna 30, the combination of MAC addresses transmitted from the wireless on-board station 15 of the train 10 via the on-board antenna 16. The wireless ground base station 31 outputs the received combination of MAC addresses to the ground control device 32 via the ground network 34. Note that, when the received combination of MAC addresses includes noise or the like, and a reception signal is in a state where the content of the combination of the MAC addresses cannot be read, the wireless ground base station 31 may discard the received combination of MAC addresses, and may not output the received combination of MAC addresses to the ground control device 32. The ground network 34 is, for example, an Internet line, a dedicated wired line, or the like, but is not limited thereto. The ground network 34 may have a configuration in which a part is configured by a wireless communication line and the rest is configured by the Internet line or a dedicated wired line described above.

The ground control device 32 uses the combination of MAC addresses to search a database in which a correspondence between a combination of MAC addresses and a formation number of the train 10 is registered. Here, for example, when the train 10 is manufactured, the ground control device 32 holds the database in which the correspondence between a combination of the MAC addresses set in the on-board control devices 11 and 12 installed on the train 10 and a formation number of the train 10 on which the on-board control devices 11 and 12 are installed is registered. For example, the ground control device 32 receives information on the combination of MAC addresses and the formation number of the train 10 from the ground terminal 33 via the ground network 34, and holds the information in the database. In addition to when the train 10 is manufactured, the ground control device 32 may also receive the information on the combination of MAC addresses and the formation number of the train 10 from the ground terminal 33 when the on-board control devices 11 and 12 are removed from the train 10 due to maintenance and inspection of the train 10 so that the on-board control devices 11 and 12 of different devices are installed. The ground terminal 33 is a terminal device such as a personal computer or a tablet operated by a person in charge of a railway company that operates the train 10 or the like.

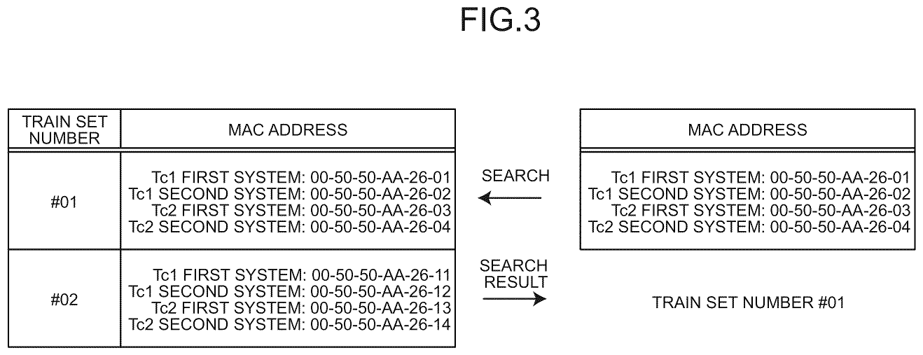

FIG. 3 is a diagram illustrating a database held by the ground control device 32 in the wireless train control system 40 and a state of search processing of the ground control device 32, according to the present embodiment. As illustrated on the left side of FIG. 3, the ground control device 32 holds a database in which a correspondence between a combination of MAC addresses and a formation number of the train 10 is registered. At this time, upon acquiring the combination of MAC addresses as illustrated on the right side of FIG. 3 from the wireless ground base station 31, the ground control device 32 searches the database by using the acquired combination of MAC addresses. In the example of FIG. 3, since a combination of MAC addresses corresponding to the acquired combination of MAC addresses exists in the database, and a formation number #01 is registered for the combination of MAC addresses, the ground control device 32 can obtain the formation number #01 as a search result. For example, in the database illustrated on the left side of FIG. 3, when the formation number #01 is for the train 10a illustrated in FIG. 1 and a formation number #02 is for the train 10b illustrated in FIG. 1, the train 10a can acquire the formation number #01 from the ground control device 32 by transmitting the combination of the MAC addresses illustrated on the right side of FIG. 3.

The ground control device 32 performs control to transmit a search result obtained by searching the database, to the train 10 via the wireless ground base station 31. The ground control device 32 searches the database by using the combination of the MAC addresses as described above, and performs control to transmit information on the formation number as the search result when the information of the formation number is obtained. Whereas, when the ground control device 32 search the database by using the combination of MAC addresses, but a combination of MAC addresses matching the combination of MAC addresses used for the search does not exist in the database, that is, when there is no formation number corresponding to the combination of MAC addresses, the ground control device 32 performs control to transmit a notification indicating that there is no formation number matching the combination of MAC addresses as the search result.

Note that, the case has been described in which the ground control device 32 holds the database in which the correspondence between a combination of MAC addresses and a formation number of the train 10 is registered, but the present disclosure is not limited thereto. A configuration other than the ground control device 32 may hold the database in which the correspondence between a combination of MAC addresses and a formation number of the train 10 is registered. In this case, the ground control device 32 searches the external database via the ground network 34 by using a combination of MAC addresses.

The ground terminal 33 receives an operation from the person in charge or the like of the railway company that operates the train 10, and performs new registration, change of registered items, and the like on the database in which the correspondence between a combination of MAC addresses and a formation number of the train 10 is registered, at the time of manufacturing the train 10, at the time of maintenance and inspection of the train 10, and the like.

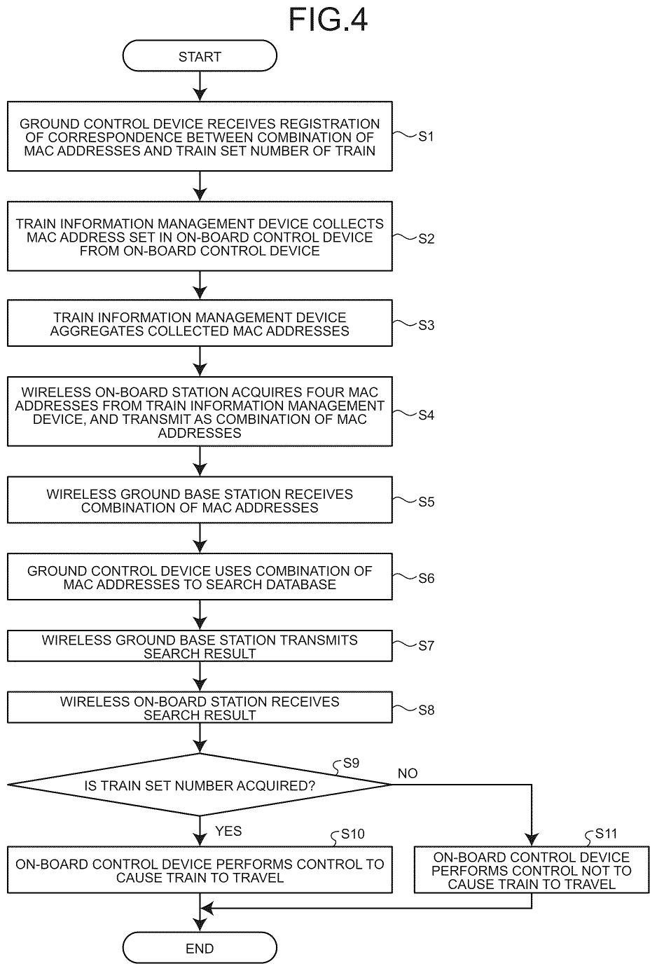

Next, an operation of each device when the on-board control devices 11 and 12 of the train 10 acquire information on the formation number in the wireless train control system 40 will be described. FIG. 4 is a flowchart illustrating an operation of each device when the on-board control devices 11 and 12 of the train 10 acquire information on a formation number in the wireless train control system 40 according to the present embodiment.

First, when the train 10 is newly manufactured, or when the on-board control devices 11 and 12 installed on the train 10 are changed at a time of maintenance and inspection of the train 10 in operation, the person in charge of the railway company that operates the train 10 or the like registers a correspondence between a combination of MAC addresses and a formation number of the train 10 in the database of the ground control device 32. That is, the ground control device 32 receives registration of the correspondence between a combination of MAC addresses and a formation number of the train 10, in the held database (step S1).

When the operation of the train 10 is started, that is, when power is applied in the train 10, the train information management device 13 collects a MAC address set in the on-board control device 11, from the on-board control device 11. Further, the train information management device 14 collects a MAC address set in the on-board control device 12, from the on-board control device 12 (step S2). In the present embodiment, the train information management device 13 collects two MAC addresses from the on-board control device 11, and the train information management device 14 collects two MAC addresses from the on-board control device 12.

The train information management devices 13 and 14 aggregate the collected MAC addresses (step S3). As described above, the train information management device 14 outputs the two MAC addresses collected from the on-board control device 12, to the train information management device 13 of the car on which the wireless on-board station 15 is installed. The train information management device 13 acquires the two MAC addresses from the train information management device 14.

The wireless on-board station 15 acquires four MAC addresses from the train information management device 13, and transmits the acquired four MAC addresses as a combination of MAC addresses to the wireless ground base station 31 on the ground via the on-board antenna 16 (step S4).

On the ground, the wireless ground base station 31 receives, via the ground antenna 30, the combination of MAC addresses transmitted from the wireless on-board station 15 of the train 10 via the on-board antenna 16 (step S5). The wireless ground base station 31 outputs the received combination of MAC addresses to the ground control device 32 via the ground network 34.

The ground control device 32 uses the combination of MAC addresses acquired from the wireless ground base station 31 to search the database in which the correspondence between a combination of MAC addresses and a formation number of the train 10 is registered (step S6). The ground control device 32 outputs a search result to the wireless ground base station 31.

The wireless ground base station 31 transmits the search result acquired from the ground control device 32 to the train 10 via the ground antenna 30 (step S7).

In the train 10, the wireless on-board station 15 receives the search result via the on-board antenna 16 (step S8). The wireless on-board station 15 outputs the received search result to the train information management device 13. The train information management device 13 notifies the train information management device 14 and the on-board control device 11 of the acquired search result. The train information management device 14 notifies the on-board control device 12 of the acquired search result.

The on-board control devices 11 and 12 perform control based on the acquired search result in the train 10. Specifically, when the on-board control devices 11 and 12 acquire a formation number as the search result (step S9: Yes), the on-board control devices 11 and 12 perform control to cause the train 10 to travel (step S10). That is, the on-board control devices 11 and 12 are normally activated when the operation of the train 10 is started, that is, when the power is applied in the train 10. When the search result is a notification that there is no formation number matching the combination of the MAC addresses transmitted from the wireless on-board station 15 (step S9: No), the on-board control devices 11 and 12 perform control not to cause the train 10 to travel (step S11). For example, the on-board control devices 11 and 12 prevent the train 10 from moving, by performing control such as applying emergency braking.

Here, for cases where the search result acquired by the on-board control devices 11 and 12 is a notification that there is no formation number matching the combination of MAC addresses (step S9: No), the following two patterns are actually conceivable. A first pattern is a case where the train 10 is newly manufactured, and the correspondence between a combination of MAC addresses of the on-board control devices 11 and 12 and a formation number of the train 10 has not been registered in the database by the person in charge of the railway company or the like. A second pattern is a case where the train 10 is subjected to maintenance and inspection, and the on-board control devices 11 and 12 installed on the train 10 have been replaced, but the registered contents of the database have not been updated by the person in charge of the railway company or the like. Therefore, when the search result is a notification that there is no formation number matching the combination of the MAC addresses transmitted from the wireless on-board station 15 (step S9: No), in addition to performing control not to cause the train 10 to travel (step S11), the on-board control devices 11 and 12 may display a message prompting a driver etc. of the train 10 to check the registered contents of the database, on a monitor device (not illustrated) etc. installed on a cab or the like of the train 10.

Next, a hardware configuration of the wireless train control system 40 according to the present embodiment will be described. In the wireless train control system 40, the wireless on-board station 15 and the wireless ground base station 31 are communication devices. The on-board antenna 16 and the ground antenna 30 are antenna elements. The ground terminal 33 is a terminal device such as a personal computer or a tablet. The on-board control devices 11 and 12, the train information management devices 13 and 14, and the ground control device 32 are each implemented by processing circuitry. The processing circuitry may be a memory that stores a program and a processor that executes the program stored in the memory, or may be dedicated hardware. The processing circuitry is also referred to as a control circuit.

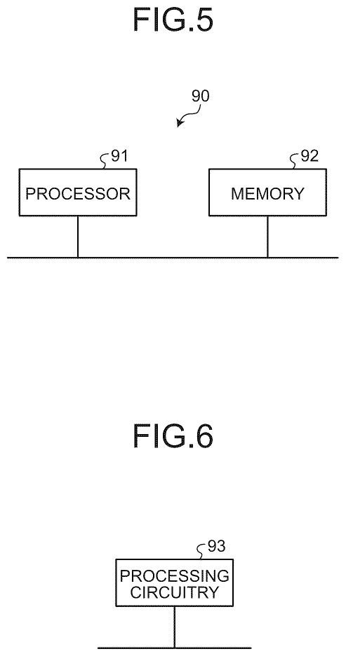

FIG. 5 is a diagram illustrating an exemplary configuration of processing circuitry 90 when processing circuitry of the wireless train control system 40 according to the present embodiment is implemented by a processor 91 and a memory 92. The processing circuitry 90 illustrated in FIG. 5 is a control circuit, and includes the processor 91 and the memory 92. When the processing circuitry 90 is configured with the processor 91 and the memory 92, each function of the processing circuitry 90 is implemented by software, firmware, or a combination of software and firmware. The software or the firmware is described as a program and stored in the memory 92. In the processing circuitry 90, the processor 91 reads and executes the program stored in the memory 92 to implement each function. That is, the processing circuitry 90 includes the memory 92 for storage of a program by which processing of the wireless train control system 40 is executed as a result. This program can also be said as a program for causing the wireless train control system 40 to execute each function implemented by the processing circuitry 90. This program may be provided by a storage medium in which the program is stored, or may be provided by other means such as a communication medium.

The program described above can be said as a program for causing the wireless train control system 40 to execute: a first step in which the train information management devices 13 and 14 collect identification information from the on-board control devices 11 and 12 which are installed on a specified car in the train 10 having the redundant transmission system and for which the identification information for performing communication in any of the transmission system is set; a second step in which the wireless on-board station 15 acquires the identification information from the train information management devices 13 and 14 and transmits a combination of the identification information; a third step in which the wireless ground base station 31 receives the combination of the identification information; a fourth step in which the ground control device 32 performs control to use the combination of the identification information to search a database in which a correspondence between a combination of the identification information and a formation number of the train 10 is registered, and transmit a search result to the train 10 via the wireless ground base station 31; a fifth step in which the train information management devices 13 and 14 acquire the search result via the wireless on-board station 15 and notify the on-board control devices 11 and 12 of the search result; and a sixth step in which the on-board control devices 11 and 12 perform control based on the acquired search result.

Here, the processor 91 is, for example, a central processing unit (CPU), a processing device, an arithmetic device, a microprocessor, a microcomputer, a digital signal processor (DSP), or the like. Further, the memory 92 corresponds to a nonvolatile or volatile semiconductor memory such as a random access memory (RAM), a read only memory (ROM), a flash memory, an erasable programmable ROM (EPROM), or an electrically EPROM (EEPROM, registered trademark), a magnetic disk, a flexible disk, an optical disk, a compact disk, a mini disk, or a digital versatile disc (DVD).

FIG. 6 is a diagram illustrating an exemplary configuration of processing circuitry 93 in a case where processing circuitry included in the wireless train control system 40 according to the present embodiment is configured by dedicated hardware. The processing circuitry 93 illustrated in FIG. 6 corresponds to, for example, a single circuit, a composite circuit, a programmed processor, a parallel-programmed processor, an application specific integrated circuit (ASIC), a field programmable gate array (FPGA), or a combination thereof. Note that a part of the processing circuitry 93 may be implemented by dedicated hardware, and a part may be implemented by software or firmware. In this manner, the processing circuitry 93 can implement the individual functions described above by dedicated hardware, software, firmware, or a combination thereof.

As described above, according to the present embodiment, in the wireless train control system 40, the train information management devices 13 and 14 of the train 10 collect MAC addresses set in the on-board control devices 11 and 12 from the on-board control devices 11 and 12, and the wireless on-board station 15 transmits a combination of the MAC addresses to the ground control device 32. The ground control device 32 performs control to use the combination of the MAC addresses to search a database in which a correspondence between a combination of MAC addresses and a formation number of the train 10 is registered, and transmit a search result to the train 10. When the on-board control devices 11 and 12 acquire a formation number of the train 10 as the search result, the on-board control devices 11 and 12 of the train 10 perform control to cause the train 10 to travel. Thus, in the wireless train control system 40, even when the number of trains 10 whose operation is controlled by the wireless train control system 40 increases, the on-board control devices 11 and 12 can acquire information on the formation number of the train 10 on which the on-board control devices 11 and 12 are installed, without changing hardware depending on the number of the train formations that exist of train 10.

The configurations illustrated in the above embodiment illustrate one example and can be combined with another known technique, and it is also possible to combine embodiments with each other and omit and change a part of the configuration without departing from the subject matter of the present disclosure.

### REFERENCE SIGNS LIST

10, 10a, 10b train; 11, 12 on-board control device; 13, 14 train information management device; 15 wireless on-board station; 16 on-board antenna; 21 station; 30 ground antenna; 31 wireless ground base station; 32 ground control device; 33 ground terminal; 34 ground network; 40 wireless train control system.

1. A wireless train control system comprising:
an on-board control device installed on a specified car in a train having a redundant transmission system, in which unique identification information for performing communication in any transmission system in the redundant transmission system is set for the on-board control device;
a train information management device to collect the identification information from the on-board control device, the train information management device being installed on the specified car;
a wireless on-board station to acquire the identification information from the train information management device and transmit a combination of the identification information;
a wireless ground base station to receive a combination of the identification information; and
a ground control device to perform control to use a combination of the identification information to search a database in which a correspondence between a combination of the identification information and a formation number of the train is registered, and transmit a search result to the train via the wireless ground base station, wherein
the train information management device acquires the search result via the wireless on-board station and notifies the on-board control device of the search result, and
the on-board control device performs control based on the acquired search result.

2. The wireless train control system according to claim 1, wherein
the on-board control device performs control to cause the train to travel when the on-board control device acquires the formation number as the search result, and performs control not to cause the train to travel when the search result is a notification that there is no formation number matching a combination of the identification information transmitted from the wireless on-board station.

3. The wireless train control system according to claim 1, wherein
the wireless on-board station directly acquires the identification information from a first train information management device installed on a car on which the wireless on-board station is installed, and the wireless on-board station acquires the identification information from a second train information management device installed on a different car via the first train information management device.

4. The wireless train control system according to claim 1, wherein
the train includes, for the redundant transmission system, the on-board control device for a first system and the on-board control device for a second system respectively in a front car and a rear car that are the specified cars,
the identification information is a media access control address unique to each of the on-board control devices, and
a combination of the identification information is a combination of four media access control addresses.

5. A formation number acquisition method comprising:
collecting, by a train information management device, unique identification information from an on-board control device that is installed on a specified car in a train having a redundant transmission system, in which the identification information for performing communication in any transmission system in the redundant transmission system is set for the on-board control device;
acquiring, by a wireless on-board station, the identification information from the train information management device and transmitting a combination of the identification information;
receiving, by a wireless ground base station, combination of the identification information;
performing, by a ground control device, control to use a combination of the identification information to search a database in which a correspondence between a combination of the identification information and a formation number of the train is registered, and transmitting a search result to the train via the wireless ground base station;
acquiring, by the train information management device, the search result via the wireless on-board station and notifies the on-board control device of the search result; and
performing, by the on-board control device, control based on the acquired search result.

6. The formation number acquisition method according to claim 5, wherein
in the performing the control based on the acquired search result, the on-board control device performs control to cause the train to travel when the on-board control device acquires the formation number as the search result, and performs control not to cause the train to travel when the search result is a notification that there is no formation number matching a combination of the identification information transmitted from the wireless on-board station.

7. The formation number acquisition method according to claim 5, wherein
in the acquiring the identification information from the train information management device, the wireless on-board station directly acquires the identification information from a first train information management device installed on a car on which the wireless on-board station is installed, and the wireless on-board station acquires the identification information from a second train information management device installed on a different car via the first train information management device.

8. The formation number acquisition method according to claim 5, wherein
the train includes, for the redundant transmission system, the on-board control device for a first system and the on-board control device for a second system respectively in a front car and a rear car that are the specified cars,
the identification information is a media access control address unique to each of the on-board control devices, and
a combination of the identification information is a combination of four media access control addresses.

9. The wireless train control system according to claim 2, wherein
the train includes, for the redundant transmission system, the on-board control device for a first system and the on-board control device for a second system respectively in a front car and a rear car that are the specified cars,
the identification information is a media access control address unique to each of the on-board control devices, and
a combination of the identification information is a combination of four media access control addresses.

10. The wireless train control system according to claim 3, wherein
the train includes, for the redundant transmission system, the on-board control device for a first system and the on-board control device for a second system respectively in a front car and a rear car that are the specified cars,
the identification information is a media access control address unique to each of the on-board control devices, and
a combination of the identification information is a combination of four media access control addresses.

11. The formation number acquisition method according to claim 6, wherein
the train includes, for the redundant transmission system, the on-board control device for a first system and the on-board control device for a second system respectively in a front car and a rear car that are the specified cars,
the identification information is a media access control address unique to each of the on-board control devices, and
a combination of the identification information is a combination of four media access control addresses.

12. The formation number acquisition method according to claim 7, wherein
the train includes, for the redundant transmission system, the on-board control device for a first system and the on-board control device for a second system respectively in a front car and a rear car that are the specified cars,
the identification information is a media access control address unique to each of the on-board control devices, and
a combination of the identification information is a combination of four media access control addresses.
